(19) United States
(12) Patent Application Publication
(10) Pub. No.: US 2007/0055747 A1
(43) Pub. Date: Mar. 8, 2007

(54) Method for accessing and displaying dynamic data in web application

(76) Inventor: Tien Wai Loh, Singapore (SG)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/572,815

(22) PCT Filed: Sep. 23, 2004
(86) PCT No.: PCT/SG04/00309

§ 371 Date: Mar. 22, 2006

(30) Foreign Application Priority Data
Sep. 23, 2003 (SG) 200305550-6

(51) Int. Cl. G06F 15/16

(52) U.S. Cl. 709/219

(57) ABSTRACT

A method is provided for accessing and displaying dynamic data from diverse data sources in web applications. The method includes a platform that supports web page generation by mixing HTML (HyperText Markup Language) with xml-like tags capable of encapsulating programming logic, a set of Interfaces, and a set of tags that facilitates the use of the aforesaid set of Interfaces. The benefit of using such a method is that it offers simpler presentation code, and better separation of programming logic from page design.

### FIELD OF THE INVENTION

This invention generally relates to the area of dynamic content generation for web pages.

### BACKGROUND OF THE INVENTION

Web application development that is currently in existence usually comprises the design of web pages, and the design of programming logic. As each requires different skill sets, it is best that they be handled by two different groups of people, i.e. page designers for designing web pages, and software developers for designing the programming logic.

One approach that is used to achieve the separation of web page design from the programming logic design is the Model-View-Controller (MVC) pattern as shown in FIG. 1. In this pattern, a controller component 102 interprets a request submitted by the browser 101 and calls model components 103 to make the necessary changes. After the necessary changes have been made, the controller then selects and calls an appropriate view component 104 to generate a response back to the browser 101. In this MVC pattern, work separation is hoped to be achieved by having a designer to work on the view component104 separately from a programmer who works on the controller component 102 and the model component 103.

Technologies like Java Server Pages (JSP) and Microsoft™ Active Server Pages (ASP) have been popular for developing web applications that provide dynamic content. They allow page designers to mix HTML code with scripting code and xml-like tags capable of encapsulating programming logic, to generate dynamic content web pages. This capability is often used for implementing the view component of the MVC pattern. A typical implementation of MVC pattern using Java Servlet and JSP technologies is shown in FIG. 2, where the controller components are implemented using Java servlets 202, the model components using Java objects 203, and the view components using JSP pages 204.

An example of a JSP page in which HTML tags are mixed with programming logic is shown below:

```
<%@ page import=“java.sql.*” %>
<html>
<head>
<title>List of Employees</title>
</head>
<body>
    <h1>List of employees</h1>
    <%
    try
    {
        Class.forName(“org.postgresql.Driver”).newInstance( );
        java.sql.Connection conn;
    conn =
DriverManager.getConnection(“jdbc:postgresql://localhost/mydatabase”,
        “username”, “password”);
    Statement stmt = conn.createStatement( );
    ResultSet rs = stmt.executeQuery(“select * from employee”);
%>
    <table border=2 cellpadding=5 cellspacing=5>
    <tr>
        <th>First Name</th>
        <th>Last Name</th>
        <th>Gender</th>
        <th>Age</th>
    </tr>
    <%
    while (rs.next( ))
    {
        String first_name = rs.getString(1);
        String last_name = rs.getString(2);
        String gender = rs.getString(3);
        int age = rs.getInt(4);
    %>
        <tr>
            <td><%=first_name%></td>
            <td><%=last_name%></td>
            <td><%=gender%></td>
            <td<%=age%>/td>
        </tr>
    <%
    }
    rs.close( );
    stmt.close( );
    conn.close( );
    %>
    </table>
<%
}
catch (Exception e)
{
    e.printStackTrace( );
}
%>
</body>
</html>
```

Due to the complexity of the web pages, as illustrated in the example above, page designers must have working knowledge of a suitable scripting language (i.e. language of the programming logic) to design a web page.

To remove the need for the designer to know scripting languages, one solution is to define tags capable of encapsulating programming logic to eliminate the use of scripting language in web pages. Such tags are defined by the programmer and specified to the designer so that the designer can use the tags in a JSP file replacing the programming logic, in positions where programming logic would be. A web sever producing the web page executes the replaced programming codes when it picks up a tag.

As is known in the relevant art of web page design and related activities, an Interface is a contract, or protocol, that defines a collection of services that a service provider must provide to its Clients, i.e. an Interface is a specification of operations that can be applied to an object. In Java language, services in the Interface are provided as Methods, and service providers are Classes that implement the Methods. An Interface only defines ‘empty’ Methods. It is during implementation of the Interface in a Class that program steps are specified and entered into the Methods.

An example of an Interface definition in Java language is shown below, which is a simple Interface defining two Methods. The first Method, setValue, is for setting the value of a specific item in a “Data Object”, i.e. a database represented by an object which implements the Interface. The second Method, getvalue, is for retrieving the value of a specific item in the Data Object.

interface DataStore

{

// to set the value of a specific item.
public void setValue(String itemName, String itemValue);
// to get the value of a specific item.
public String getValue(String itemName);

}

class MyDataStore implements DataStore
{

private HashMap internalDataStore = new HashMap( );
// implement the setValue method defined in the DataStore Interface.
public void setValue(String itemName, String itemValue)
{

internalDataStore.put(itemName, itemValue);

}
// implement the getValue method defined in the DataStore Interface.
public String getValue(String itemName)
{

String itemValue = (String) internalDataStore.get(itemName);
return itemValue;

}

}

In the above Class, which is a Data Object, MyDataStore, a Client would use the Methods ‘setValue’ and ‘getvalue’ to update or retrieve data. If the data source is changed, such that the Client has to access data in another Data Object implementing a different Interface, there will be a mismatch, e.g. mismatches occur when the Interface (or the Methods it defines) to access a Data Object is different from the Interface (or the Methods) which a Client uses.

In the above-described solution of user-defined tags, tags are designed to invoke services defined in a specific Interface. Thus, when the data source changes and a new Data Object having a different Interface has to be used, a new set of tags has to be defined to call the Methods in the Interface of the new Data Object. This approach leads to proliferation of many sets of user-defined tags; the need to represent and access data of different types of data source, each implementing different Interfaces, results in the creation of a set of tags for each type of data source. As a result, the designer has to continually learn new tags, which provide identical results to those provided by tags he was already using.

Furthermore, this approach requires page designers to understand the domains the programming codes (encapsulated by the tags) operate in, in order to use the tags correctly. The required understanding of domains, e.g. having to know which JDBC™ (Java DataBase Connectivity) driver to use and the URL (Uniform Resource Locator) of the required data source, by the page designers greatly undermines the goal of role separation of page designers and software developers. For example, a tag that encapsulates the code for accessing data in a database via JDBC™ requires the page designers to specify in tag attributes the JDBC™ driver and the database URL information.

It is therefore desirable to have a method that is able to reduce or even eliminate the use of programming language in web pages. Such a method may be able to use only a manageable number of tags and not require the user to have prior knowledge of other domains.

### SUMMARY OF THE INVENTION

In a first aspect, a method is provided for accessing and displaying dynamic content in a web page, comprising defining a set of Use-Patterns of dynamic content in web pages, defining a set of Interfaces for accessing data of diverse data sources, wherein individual Interfaces match individual Use-Patterns, defining methods in the set of Interfaces to access and display data from the diverse sources of data and defining a set of tags for calling the methods.

In a second aspect, a method is provided for accessing content in a plurality of data sources comprising providing a set of tags, each tag capable of invoking at least one method defined in a first set of Interfaces implemented by a first Data Object representing a first data source, providing an Adapter object which adapts a second set of Interfaces of a second Data Object representing a second data source to the first set of Interfaces, wherein the Adapter removes mismatches between the second set Interfaces and the tags, whereby the set of tags is usable to invoke methods defined in the second interface to access data in the second Data Object.

In a third aspect, a method of providing a set of tags for accessing and displaying dynamic content in a web page, comprising identifying ways in which data is accessed and used, providing a set of first programs programmed to access and use data, according to the identified ways in which data is accessed and used, providing a set of tags capable of invoking the first programs, providing a means for adapting second programs to be invocable by the set of tags whereby the adapter provides the possibility of the tags invoking second programs not in the set of first programs.

Embodiments of the invention provide the advantage of preventing proliferation of user-defined tags by (i) identifying webpage designers' Use-Patterns of data and providing a set of tags for carrying out the Use-Patterns on data, and (ii) by adapting different interfaces to be invocable by the same set of tags. Therefore, there is no need for any tag other than those provided in the set of tags, either for any more Use-Patterns or for any new interface.

### DESCRIPTION OF THE DRAWINGS

Embodiments of the invention will now be described, by way of example, with reference to the accompanying drawings, in which

FIG. 1 illustrates a known model-view-controller pattern;

FIG. 2 illustrates the model-view-controller pattern of FIG. 1 implemented in Java Servlet and JavaServer Page (JSP) technologies;

FIG. 3 depicts the relationship between the components in an embodiment of the present invention; and

FIG. 4 illustrates the embodiment of FIG. 3 in use.

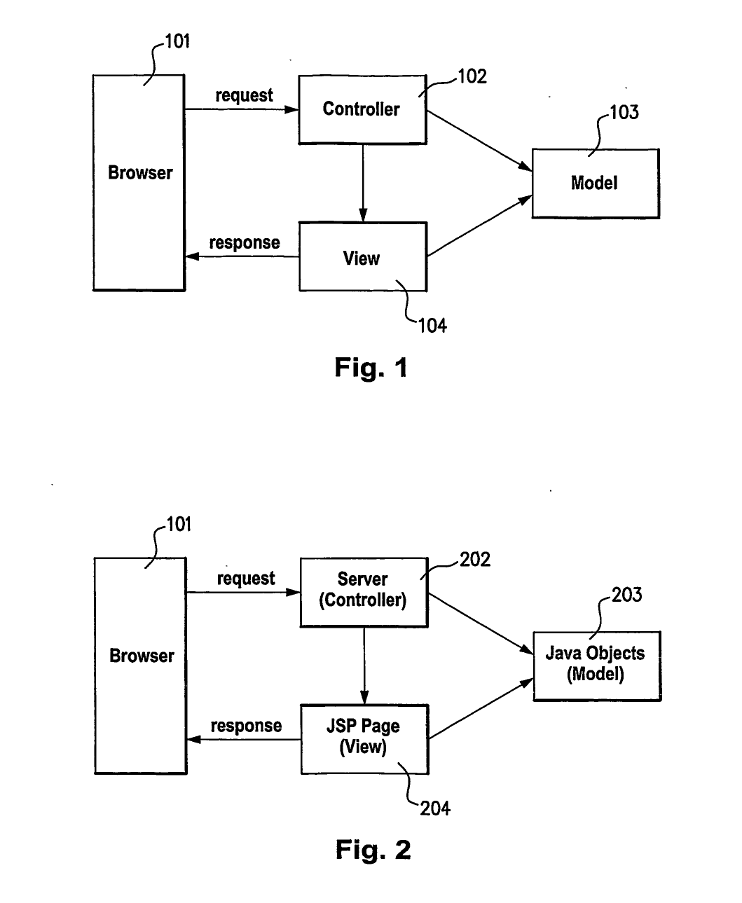

### DETAILED DESCRIPTION OF THE INVENTION

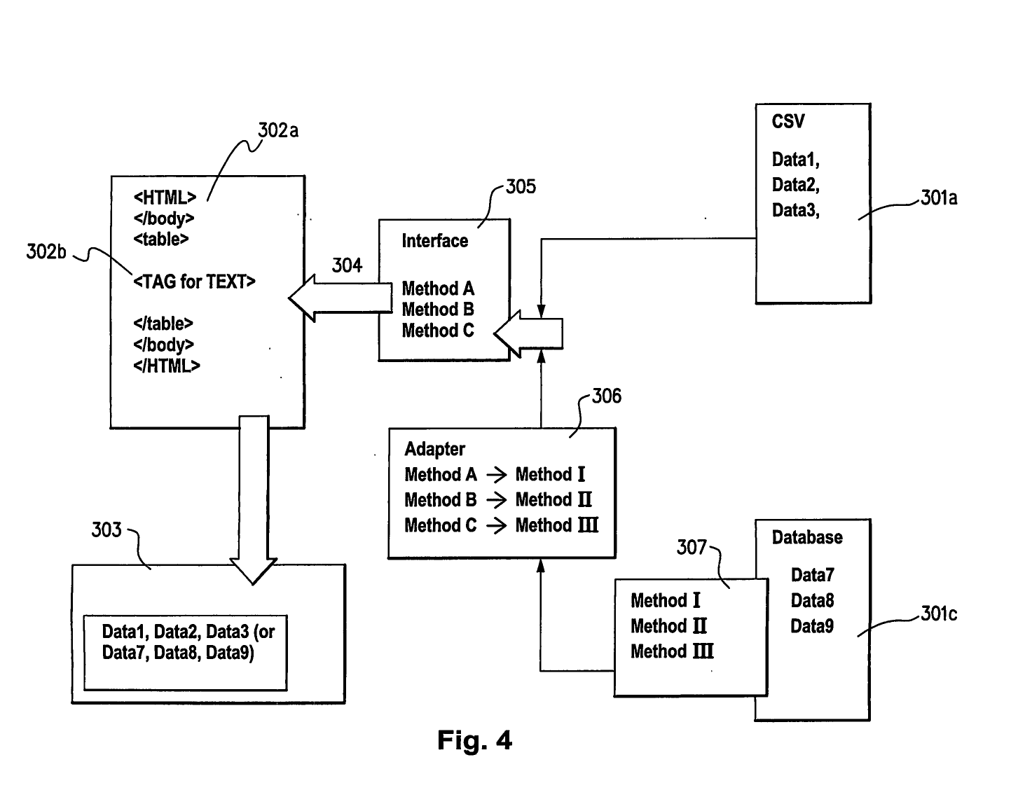

FIG. 4 shows an exemplary embodiment of the present invention which provides a set of tags 302b. The tags are inserted into a script file 302a of a web page, such a JSP, HTML, XML file, etc. When the script file 302a is processed, at 304, by a server having a suitable platform for processing the tags 302b, the tags 302b invoke programs 305 which access data from a data source 301a and insert the data into the script file 302a Accessing data is taken here to mean using data, retrieving data, evaluating data, looping through a set of data or any other way of determining characteristics of a set of data, as is understood by a man skilled in the relevant art.

A Set of Use-Patterns

In a first exemplary embodiment, a set of patterns of the use of dynamic data content in web pages is identified and defined from how data is commonly used in a dynamically produced web page. The set of patterns includes:
Pattern 1: Accessing and displaying the string value of a data item.
Pattern 2: Iterating through a collection of Data Objects (A Data Object comprises at least one data item with a value. An example of a Data Object is an employee record with data items first_name, last_name, gender and age which values are “Smith”, “John”, “Male”and “35”, respectively).
Pattern 3: Determining whether specific data items in a collection of Data Objects contain a specific value.

The aforementioned set of three patterns hereinafter will be referred to as “MyDataUsePatterns”.

A Set of Interfaces For Accessing Data of Diverse Data Sources

Furthermore, in the present embodiment, a set of Interfaces for accessing data of diverse data sources supporting the MyDataUsePatterns is provided. The set of Interfaces comprises services, or Methods, as shown below:
Interface 1. An Interface for accessing the string value of a data item. This Interface supports Pattern 1 of MyDataUse Patterns. In other words, the Methods defined by this Interface correspond to the patterns in Pattern 1. An example of such an Interface is one that contains the following method:
   // Return the string value of the specified item.
   String getValue(String item)
Interface 2. An Interface for iterating through a collection and getting the size of a collection. This Interface supports Pattern 2 of MyDataUsePatterns. An example is an Interface that contains the following methods:
   // Move to before the first element.
   void beforeFirst( )
   // Return true if there is next element else return false.
   boolean hasNext( )
   // Move to the next element. Return true if there is next element else return
   // false.
   boolean next( )
   // Return the size of the collection. If the size could not be determined
   // return-1.
   Int getSize( )
Interface 3. An Interface for determining whether specific data items in a collection of Data Objects contain a specific value. This Interface supports Patterns 3 of MyDataUsePatterns. An example is an Interface that contains the following method:
   // Return true if the values of the specified data item in a collection
   // contain the specified match value.
   boolean containsValue(String item, String matchValue)

As this is a set of Interfaces, it can be used to access data from different types of data sources by using an appropriate Adapter object

Adapting an Interface to Obtain Data from a Mismatching Data Object

In order for the Method as defined by an Interface to access information from a ‘mismatching’ Data Object, an Adapter can be used to adapt the Interface of the Data Object. The Adapter converts the Interface of the ‘mismatching’ Data Object, into the Interface a Client, e.g. a tag, expects. Methods defined in the Adapter have the same names, or signatures, as the Methods defined in the Interface which the Client originally invokes (see line (1) in the following example). Thus, the Client has no problem in invoking the Methods defined in the Adapter. The Methods in the Adapter, in turn, call the target Class, or Methods defined in the original Interface of the ‘mismatching’ Data Object, to carry out the request (see line (2) in the following example). In this way, mismatches between the Methods a client expects and the Methods provided by a differing Interface are eliminated.

The following is an example of an Adapter that converts the Interface of a HashMap object to the DataStore Interface described above.

```
class MyHashMapToDataStoreAdapter implements DataStore
{
private HashMap myAdaptee;
public MyHashMapToDataStoreAdapter(HashMap adaptee)
    {
    myAdaptee = adaptee;
    }
// implement the setValue method defined in the DataStore Interface.
    public void setValue(String itemName, String itemValue) ---- (1)
    {
    myAdaptee.put(itemName, itemValue); ---------------------------(2)
    }
// implement the getValue method defined in the DataStore Interface.
    public String getValue(String itemName)
    {
    String itemValue = (String) myAdaptee.get(itemName);
    return itemValue;
    }
}
```

In the above example, the HashMap object uses a ‘get’ and a ‘put’ Method instead of the ‘getvalue’ and ‘setValue’ Methods defined in the DataStore Interface. Therefore, Clients which use the DataStore Interface and which only know the Methods ‘getvalue’ and ‘setValue’, do not know the Methods in the HashMap object. To allow such Clients to use the HashMap Interface, an Adapter, MyHashMapToDataStoreAdapter, is used to adapt the HashMap object. In doing so, the Adapter implements the Methods of the DataStore Interface, ‘getvalue’ and ‘setValue’, to invoke the Methods in the HashMap object. Thus, the Client calls ‘setValue’ (see line (1) ) in an instance of MyHashMapToDataStoreAdapter, which, in turn, calls the adaptee which is a HashMap instance to carry out the ‘put’ Method (see line (2) ).

Furthermore, as the Adapter adapts the Interface of the new Data Object, the connection to the new data source is defined in the Adapter, which removes the need for the designer to specify the URL and other domain information in the JSP page. Thus, the designer does not need to know and understand domains.

More details regarding the use of an Adapter to convert the Interface of a Class into another Interface which a Client expects can be found in known design pattern literature. For example, “Design Patterns”by Gamma, Helm, Johnson & Vlissides, ISBN 0-201-63361-2.

The set of Interfaces mentioned above will be referred to as “MyDataAccessInterfaces”from hereon. An object that implements one or more of the Interfaces of MyDataAccessInterfaces from hereon will be referred to as “MyDataAccessObject”.

A Set of Tags

A set of tags facilitating the use of the set of Interfaces, MyDataAccessInterfaces, in web pages is defined. The tags are therefore the ‘Clients’ mentioned above which call Methods in a Data Object implementing an Interface.

The tags includes, as non-exhaustive examples, tags that perform one or more of the following functions:
displaying the value of a data item;
iterating through a collection of Data Objects;
getting the size of a collection;
evaluating the tag body based on the result of testing the value of a data item;
evaluating the tag body based on the result of testing the size of a collection; or
evaluating the tag body based on the result of testing the values of a data item in collection of Data Objects.

A set of tags such as those above will be referred to as “MyDataTags”from now on.

Descriptions of some exemplary tags are given in the following:

Tag: data: The data tag obtains and displays the string value of a data item. For example, the tag <mydatatag:data name=”employee”item=”first_name”> retrieves and display the data item “first_name” of the MyDataAccessObject named “employee”. The MyDataAccessObject in this case implements at least Interface 1 of MyDataAccessInterfaces, i.e. the tag invokes Methods in Interface 1.

Tag: iterator: The iterator tag iterates over a collection of data elements, and is used in conjunction with the data tag. For example, the tag <mydatatag:iterator name=”employees”> with a tag body that includes the data tag <mydatatag:data name=”employees”item=”first_name”> iterates through all employees and displays their first names. The MyDataAccessObject in this case implements at least Interface 1 and 2 of MyDataAccessInterfaces.

Tag: iteratorSize: The iteratorSize tag displays the size value of a collection. For example, the tag <mydatatag:iteratorSize name=”employees”> will get and display the size of a collection of employees. The MyDataAccessObject in this case implements at least Interface 2 of MyDataAccessInterfaces.

Tag: dataIn: The dataIn tag tests if specific data items of a collection of Data Objects contain a specific value. If the test returns true, then the body of the tag is evaluated. For example, the tag <mydatatag:dataIn name=”employees”item=”first_name” match=”Smith”> determines if the first_name of one or more employees are “Smith”. If the test returns true, the body of the tag is evaluated. The MyDataAccessObject in this case implements at least Interface 3 of MyDataAccessInterfaces.

Tag: dataNotIn: Contrary to the dataIn tag, the dataNotIn tag tests if specific data items of a collection of Data Objects do not contain a specific value. If the test returns true, the body of the tag is evaluated. The MyDataAccessObject in this case implements at least Interface 3 of MyDataAccessInterfaces.

Tag: dataEqual: The dataEqual tag tests if the value of a data item equals to a specific value. If the test returns true, then the body of the tag is evaluated. For example, the tag <mydatatag: dataEqual name=”employee”item=”first_name”match=”Smith”> would determine if the data item “first_name”of MyDataAccessObject named “employee”is equal to “Smith”. If the test returns true, the body of the tag is evaluated. The MyDataAccessObject in this case implements at least Interface 1 of MyDataAccessInterfaces.

Tag: dataNotEqual: Contrary to the dataEqual tag, the dataNotEqual tag tests if the value of a data item is not equal to a specific value. If the test returns true, then the body of the tag is evaluated. The MyDataAccessObject in this case implements at least Interface 1 of MyDataAccessInterfaces.

Tag: dataItemEqual: The dataItemEqual tag tests if the values of two data items are equal. If the test returns true, then the body of the tag is evaluated. For example, the tag <mydatatag: dataItemEqual name=”employee”item=”first_name”matchname=”manager”matchitem=”first_name”> determines if the data item “first_name”of MyDataAccessObject named “employee”is equal to the data item “first_name”of another MyDataAccessObject named “manager”. If the test returns true, the body of the tag is evaluated. The MyDataAccessObjects in this case implements at least Interface 1 of MyDataAccessInterfaces.

Tag: dataItemNotEqual: Contrary to the dataItemEqual tag, the dataItemNotEqual tag tests if the values of two data items are not equal. If the test returns true, then the body of the tag is evaluated. The MyDataAccessObjects in this case implements at least Interface 1 of MyDtaAccessInterfaces.

Tag: dataItemIn: The dataItemIn tag tests if specific data items of a collection of Data Objects contain the value of a specific data item of another Data Object. If the test returns true, then the body of the tag is evaluated. For example, the tag <mydatatag:dataItemIn name=”employees”item=”first_name”matchName=”manager”matchItem=“first_name”> determines if the first_name of one or more employees equal to the first_name of the manager. If the test returns true, the body of the tag is evaluated. The MyDataAccessObject “employees”in this case implements at least Interface 3 of MyDataAccessInterfaces. The MyDataAccessObject “manager”in this case implements at least Interface 1 of MyDataAccessInterfaces.

Tag: dataItemNotIn: Contrary to the dataItemIn tag, the dataItemNotIn tag tests if specific data items of a collection do not contain the value of a specific data item of another Data Object. If the test returns true, then the body of the tag is evaluated. The MyDataAccessObject for the collection implements at least Interface 3 of MyDataAccessInterfaces. The MyDataAccessObject for data item implements at least Interface 1 of MyDataAccessInterfaces.

Tag: iteratorSizeEqual: The iteratorSizeEqual tag tests if the size of a specific collection equals to a specific value. If the test returns true, then the body of the tag is evaluated. For example, the tag <mydatatag: iteratorSizeEqual name=“employees”match=“0”> determines if the size of the collection of employees equals to 0. If the test returns true, the body of the tag is evaluated. The MyDataAccessObject in this case implements at least Interface 2 of MyDataAccessInterfaces.

Tag: iteratorSizeNotEqual: Contrary to the iteratorSizeEqual tag, the iteratorSizeNotEqual tag tests if the size of a specific collection not equals to a specific value. If the test returns true, then the body of the tag is evaluated. The MyDataAccessObject in this case implements at least Interface 2 of MyDataAccessInterfaces.

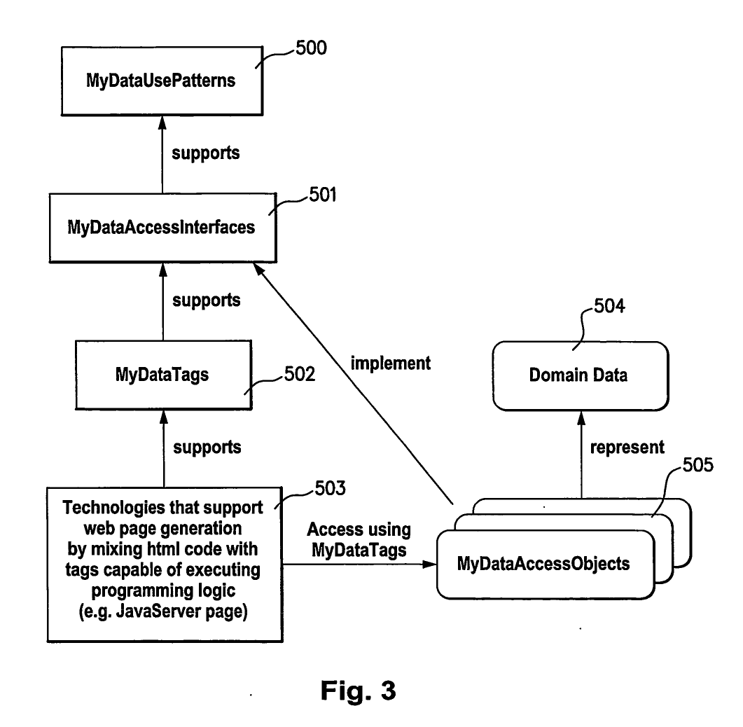

FIG. 3 depicts the relationship between components of the present embodiment. MyDataUsePatterns 500 is defined according to the Use-Patterns of dynamic content in web pages. MyDataAccessInterfaces501 is defined to support MyDataUsePatterns 500. MyDataTags 502 is created to facilitate the use of MyDataAccessInterfaces 501 in web pages. Technologies 503 that support page generation by mixing HTML code and tags capable of executing programming logic are used to incorporate or support MyDataTags 502. By incorporating or supporting MyDataTags 502, these technologies 503 can then use MyDataTags 502 to access domain data 504, represented in the form of MyDataAccessObject 505, in their web page. The MyDataAccessObjects 505 implements one or more Interfaces of MyDataAccessInterfaces 501 and is thus via MyDataTags 502.

### AN EXAMPLE

To illustrate an operation of the embodiment, the JSP code of a web page, in which the tags invoke Interfaces as defined according to the three Use-Patterns identified above, showing an employee record, is shown below.

ViewEmployee.jsp

```
<%@ taglib uri=”/src/tags/taglib.tld” prefix=”mydatatag” %>
<html>
<head>
  <title>View Employee</title>
<head>
<body>
<b>First Name:</b><mydatatag :data name=”employee” item=
”first_name”/><br>
<b>Last Name:</b><mydatatag :data name=”employee” item=
”last_name”/><ibr>
<b>Gender:</b><mydatatag :data name=”employee” item=”gender”/>
<br>
<b>Age:</b><mydatatag : data name=”employee” item=”age”/><br>
<hr>
<b>Work History</b><br>
<table>
  <tr>
  <td>From Year</td>
  <td>To Year</td>
  <td>Company</td>
  <td>Position</td>
</tr>
<mydatatag :iterator name=”work_history”>
<tr>
  <td><mydatatag :data name=”work_history” item=”from_year”/></td>
  <td><mydatatag :data name=”work_history” item=”to_year”/></td>
  <td><mydatatag :data name=”work_history” item=”company”/></td>
  <td><mydatatag :data name=”work_history” item=”position”/></td>
</tr>
</mydatatag:iterator>
<mydatatag:iteratorSizeEqual name=”work_history” match=”0”>
<tr>
  <td colspan=4>No record found!</td>
</tr>
</mydatatag:iteratorSizeEqual>
</table>
</body>
</html>
```

The above code uses two MyDataAccessObjects, one for accessing the employee data and one for accessing the work history of the employee. The MyDataAccessObject for the employee data has implemented Interface 1 of MyDataAccessInterfaces, and contains data items first_name, last_name, gender and age. The values of these data items are accessed and displayed using the data tag from MyDataTags. The MyDataAccessObject for the work history has implemented Interfaces 1 and 2 of MyDataAccessInterfaces, and the collection of work history data with data items from_year, to_year, company and position. The iterator tag from MyDataTags is used for iterating over the collection of work history data and the data tag from MyDataTags is used for accessing and displaying the data items of work history data. The iteratorSizeEqual tag from MyDataTags is used for testing the size of the collection of work history and, if it is equal to 0, displays the next “No record found!”.

FIG. 4 illustrates the operation of the above embodiment. A computer running a platform for processing, at 304, a tag 302b in a script file 302a (e.g. a HTML document) detects the tag 302b and consequently invokes a Method (among Methods A, B and C) in a Data Object (not illustrated) representing a data source 301a. The Method invoked is one which is linked to the tag 302b and is defined in an Interface 302 which is implemented in the Data Object (optionally, several Methods defined in the set of Interfaces can be invoked by a single tag). When a Method in the Data Object is invoked by a tag 302b, the steps as specified in the Method are executed. However, when the source of data 301a is replaced by a new source of data, 301c, the resulting new Data Object implements a different Interface 307 which does not define the same Methods as those named in the earlier Interface 302, i.e. the tag 302b is not linked to and cannot call any Method in the new Interface 307. For example, instead of Methods A, B and C, the new Interface defines Methods I, II and III. Therefore, an Adapter 306 is used. The Adapter 306 implements the Methods defined in the original Interface 302 and during the implementation, specify steps to be executed in the Methods defined by the original Interface 302 such that, when invoked, the Methods of the original Interface 302 call Methods defined in the new Interface 307 (see example given above of MyHashMapToDataStoreAdapter class). Thus, the tag 302b, when processed, invokes a Method as defined in the original Interface 305, i.e. Methods A, B or C, which, in turn, invokes a Method implemented in the new data Object which is defined in the new Interface 307, i.e. Methods I, II or III. Thus, the new Interface 307 is adapted by Adapter 306 such that the tag 302b is able to invoke Methods implemented in the new Data Object. In this way, a tag is able to invoke Methods defined in various Interfaces implemented in different Data Objects. Thus, the need to create a new set of tags for every different Interface is removed.

As the adapting is done by the programmer ‘behind the scenes’, the designer in this case has no need to know if information displayed in the web page comes from a changed source. Therefore, the designer works with the same set of tags as before, and does not need to re-learn a new set of tags for accessing information when the source of data changes.

In summary, in this embodiment, (i) Use-Patterns are identified which cover the ways in which a designer uses data, (ii) a set of Interfaces defining Methods which support the use patterns is created, (iii) a set of tags is defined to use the Methods defined by the Interfaces. Thus, there is no need to create new tags for ways in which a designer uses data, and as an Adapter object is useable to adapt Interfaces which does not match the Methods invocable by the tags, there is also no need to create new tags for mis-matching interfaces. In this way, the present embodiment provides the possibility of preventing proliferation of tags.

The embodiment identifies a set of Use-Patterns of dynamic data in web pages. It also defines a set of Interfaces for accessing dynamic data of diverse data sources based on the aforesaid Use-Patterns. This can be used to ensure that mismatches between how dynamic data is being used in web pages and how dynamic data is being accessed are eliminated. The result is the possibility of a reduction or even elimination of the need of scripting codes often used for bridging such mismatches in web pages.

It should be understood that the description ‘web page’ is intended to include any browser readable page, whether it is accessible on the World Wide Web, or accessible only on a LAN or only in an computer which is not part of any network.

The foregoing descriptions of specific embodiments of the invention have been presented for purposes of description and illustration. It should not limit the invention to the precise forms disclosed. It is intended that the specification and examples be considered as sample information only. The full scope of the invention shall be defined by the appended claims.

1. A method for accessing and displaying dynamic content in a web page, comprising:
defining a set of Use-Patterns of dynamic content in web pages;
defining a set of Interfaces for accessing data of diverse data sources, wherein individual Interfaces match individual Use-Patterns;
defining methods in the set of Interfaces to access data from the diverse sources of data; and
defining a set of tags for calling the methods.

2. The method of claim 1 wherein a Data Object implementing the set of interfaces comprises one or more data items with values.

3. The method of claim 2, wherein the set of Use-Patterns comprises one or more patterns from a group consisting of:
a pattern of accessing and displaying the string value of a data item;
a pattern of iterating through a collection of Data Objects; and
a pattern of determining whether data items in a collection of Data Objects contain a specific value.

4. The method of claim 2, wherein the set of Interfaces includes:
an Interface for accessing the string value of a data item;
an Interface for iterating through and getting the size of a collection of Data Objects; and
an Interface for determining whether the data items in a collection of Data Objects contain a specific value.

5. The method of claim 1, wherein the set of tags calls the methods in the set of Interfaces to access data of diverse data sources in dynamic content generation.

6. The method of claim 1, further comprising adapting the set of Interfaces with an Adapter object to access a source of data.

7. The method of claim 1, wherein the set of tags comprises one or more tags from a group consisting of tags that perform the following functions:
displaying the value of a data item, iterating through a collection of Data Objects, getting the size of a collection;
evaluating tag body based on the result of testing the value of a data item; evaluating the tag body based on the result of testing the size of a collection; or
evaluating tag body based on the result of testing the values of a data item in a collection of Data Objects.

8. The method of claim 1 wherein the set of tags are used with a server having a platform capable of generating a dynamic web page from a mixture of HTML code with the tags.

9. The method of claim 1 whereby a need for programming codes for dynamic content generation in a script file of the web page is eliminated.

10. A method of accessing content in a plurality of data sources comprising:
providing a set of tags, each tag capable of invoking at least one method defined in a first set of Interfaces implemented by a first Data Object representing a first data source;
providing an Adapter object which adapts a second set of Interfaces of a second Data Object representing a second data source to the first set of Interfaces; wherein
the Adapter removes mismatches between the second set Interfaces and the tags; whereby
the set of tags is usable to invoke methods defined in the second interface to access data in the second Data Object.

11. A method of accessing content in a plurality of data sources as claimed in claim 10 further comprising:
identifying a set of Use-Patterns;
wherein the first set of Interfaces defines methods according to the set of Use-Patterns.

12. A method of accessing content in a plurality of data sources as claimed in claim 11, wherein the set of Use-Patterns comprises one or more Use-Patterns from the group consisting of:
a pattern of accessing and displaying the string value of a data item;
a pattern of iterating through a collection of Data Objects; and
a pattern of determining whether the data items in a collection of Data Objects contain a specific value.

13. A method of providing a set of tags for accessing data, comprising:
identifying ways in which data is accessed;
providing a set of first programs programmed to access and use data, according to the identified ways in which data is accessed;
providing a set of tags capable of invoking the first programs;
providing a means for adapting second programs to be invocable by the set of tags; whereby
the adapter provides the possibility of the tags invoking second programs not in the set of first programs.

14. The method of claim 13, wherein the ways in which data is accessed includes identifying a data source from which the data is accessed and a connection method thereto.

15. The method of claim 13, whereby proliferation of tags is prevented.

16. The method of claim 13, whereby the set of tags is sufficient for representing all the ways in which a tag user would want to access and use data.

17. The method of claim 13 wherein the set of tags is provided for retrieving and displaying dynamic content in a web page.
